(19) United States
(12) Patent Application Publication
(10) Pub. No.: US 2025/0287427 A1
(43) Pub. Date: Sep. 11, 2025

(54) METHODS AND APPARATUS FOR NON-PRIMARY CHANNEL ACCESS PROCEDURE

(71) Applicants: SONY GROUP CORPORATION, Tokyo (JP); SONY CORPORATION OF AMERICA, New York, NY (US)

(72) Inventors: Salvatore Talarico, Los Gatos, CA (US); Qing Xia, San Jose, CA (US)

(73) Assignees: SONY GROUP CORPORATION, Tokyo (JP); SONY CORPORATION OF AMERICA, New York, NY (US)

(21) Appl. No.: 19/064,896

(22) Filed: Feb. 27, 2025

Related U.S. Application Data
(60) Provisional application No. 63/562,738, filed on Mar. 8, 2024.
(60) Provisional application No. 63/656,705, filed on Jun. 6, 2024.

(51) Int. Cl. H04W 74/0816; H04W 84/12

(52) U.S. Cl. CPC H04W 74/0816; H04W 84/12

(57) ABSTRACT

Performing non-primary channel access procedures when channel bonding or multi-channel operation is intended to be performed by a station, and yet it is determined that the intended primary channel is busy. The station may then choose a non-primary channel to act in the manner of the primary channel, to perform wideband transmissions in an immediately subsequent transmission interval.

### CROSS-REFERENCE TO RELATED APPLICATIONS

This application claims priority to and the benefit of U.S. provisional patent application Ser. No. 63/562,738 filed on Mar. 8, 2024, incorporated herein by reference in its entirety. This application claims priority to and the benefit of U.S. provisional patent application Ser. No. 63/656,705 filed on Jun. 6, 2024, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to multi-channel operations, and more particularly to utilizing a non-primary channel when the primary channel is unavailable.

### 2. Background Discussion

The current implementations of IEEE 802.11be provide significant benefits in terms of its throughout and flexibility. However, there are issues in terms of reliability and channel utilization. For example, its indeterministic channel access procedure, especially for wideband transmissions, limits full utilization of available channel resources. In particular, for wideband transmissions, or when multi-channel or channel bounding operation is used, a mandatory Listen Before Talk (LBT) is required for each section of 20 MHz channel bandwidth. When the primary channel is required for certain operations, then transmission bottlenecks arise.

Accordingly, a need exists for improved mechanisms for assessing and determining channel utilization. The present disclosure fulfills that need and provides additional benefits over existing systems.

### BRIEF SUMMARY

Described is an apparatus and method for improving reliability and throughput in systems utilizing channel bonding or multi-channel operations. When a device intends to utilize the primary channel and finds it to be busy, then it is able under this disclosure to initiate operation on a non-primary channel, which is used as, and acts in the manner, of the primary channel to perform wideband transmission in an immediately subsequent transmission period, and thus the transmission spectrum is better utilized.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1A and FIG. 1B are communication channel diagrams of puncturing as well as the reliability bottleneck which arises when the primary channel is unavailable.

FIG. 2A and FIG. 2B are communication channel diagrams exemplifying current high level channel access procedures for channel bonding or multi-channel operations for 802.11ac, and 802.11be.

FIG. 3A and FIG. 3B are communication channel diagrams of grouping adjacent channels for channel bonding showing channelization in both the sub-5 GHz band and in the sub-6 GHz band.

FIG. 4 is a block diagram of communication station hardware, according to at least one embodiment of the present disclosure.

FIG. 5 is a block diagram of Multi-Link Device (MLD) hardware according to at least one embodiment of the present disclosure.

FIG. 6 is a communication diagram of frame exchange and switching from non-primary to primary channels, according to at least one embodiment of the present disclosure.

FIG. 7 is a communication diagram of back and forth switching between a primary and non-primary channel, according to at least one embodiment of the present disclosure.

### DETAILED DESCRIPTION

### 1. Introduction to 802.11 Throughout and Reliability

Based on the Project Authorization Request (PAR) for the IEEE P802.11bn project, the scope of this standard is to define one Medium Access Control (MAC) and several Physical Layer (PHY) specifications for wireless connectivity for fixed, portable, and moving stations (STAs) within a local area. In particular, the aim is to add ultra reliability capabilities to a Wireless LAN Area Network (WLAN), where the capability is defined for both an isolated Basic Service Set (BSS) and overlapping BSSs, and to introduce: (a) at least one mode of operation capable of increasing throughput by 25%, as measured at the MAC data service Access Point, in at least one Signal to Interference and Noise Ratio (SINR) level (Rate-vs-Range), compared to the Extremely High Throughput MAC/PHY operation; (b) at least one mode of operation capable of reducing latency by 25% for the 95th percentile of the latency distribution compared to the Extremely High Throughput MAC/PHY operation; and (c) at least one mode of operation capable of reducing MAC Protocol Data Unit (MPDU) loss by 25% compared to the Extremely High Throughput MAC/PHY operation for a given scenario, especially for transitions between BSSs.

In view of the above it should be noted that the current IEEE 802.11be standard achieves multi-Gbps throughout, sub-10 ms latency and packet losses lower than 0.1% and enhancements are needed in order to fulfill the requirements for the use cases identified for the IEEE P802.11bn project. In this case, one of the main limitations of IEEE 802.11be is in terms of reliability and due to the indeterministic channel access procedure especially for wideband transmissions. In particular, for wideband transmissions or when multi-channel or channel bounding operation is used, a mandatory Listen Before Talk (LBT) is required for each channel bandwidth composed by 20 MHz of bandwidth. When operating in this mode, one of the channel bandwidths is selected to act as a primary channel, while all other channel bandwidths that compose the total bandwidth (or BSS bandwidth) for the wideband transmission are defined as secondary channels. For a device, either an AP or a non-AP STA, to acquire the channel and a Transmit Opportunity (TXOP) and perform a wideband transmission, it has to succeed the Enhanced Distributed Channel Access (EDCA) procedure over the primary channel regardless of the secondary channels for which assessment is performed only after the primary channel is considered idle.

In 802.11ax and 802.11be, the concept of puncturing was defined, and insofar as the primary channel is assessed to be idle, wideband transmission is performed over the primary channel plus any secondary channel belonging to the initial transmission bandwidth for which the related Clear Channel Assessment (CCA) status is detected as idle. While this procedure has sensibly improved spectrum efficiency of a system compared to the legacy design, where the wideband transmission was conditional to the fact that the whole original transmission bandwidth should be idle before transmissions, and that not only the EDCA would succeed at the primary channel, but all the secondary channels would clear their related CCA assessment, the multi-channel operation still has its main bottleneck on the primary channel itself. In fact, if an OBSS transmission overlaps with the primary channel, no transmission can occur independently on the available secondary channels, leaving a substantial portion of the spectrum unutilized, which is as detrimental as the transmission bandwidth is larger.

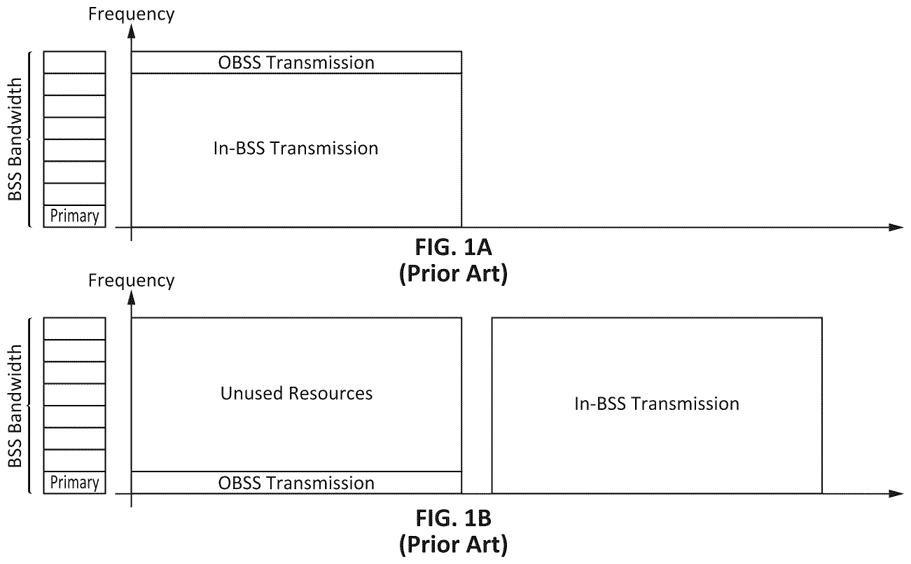

FIG. 1A and FIG. 1B depicts the case of when an OBSS transmission spanning over 20 MHz overlaps with an in-BSS transmission over a 160 MHz total bandwidth. In FIG. 1A the case is depicted of when the OBSS transmission overlaps over one the secondary channels, and in this case, puncturing is applied in the intended BSS, and in-BSS transmission is still performed, yet only over a reduced bandwidth. However, in the case when the Overlapping Basic Service Set (OBSS) transmission overlaps over the primary channel as seen in FIG. 1B, the entire in-BSS transmission is deferred, and the majority of the spectrum remains unused as the wideband transmission is not allowed according to the current design principles and conditions.

### 2. Current State of the Art

Multi-channel or channel bounding operation has been supported in Wi-Fi since 802.11n to allow transmissions over contiguous 40 MHz segments, and it was then extended in 802.11ac to allow 80 MHz and 160 MHz transmissions. In 802.11ax the feature of preamble puncturing based on the maximum operation bandwidth of 160 MHz was improved.

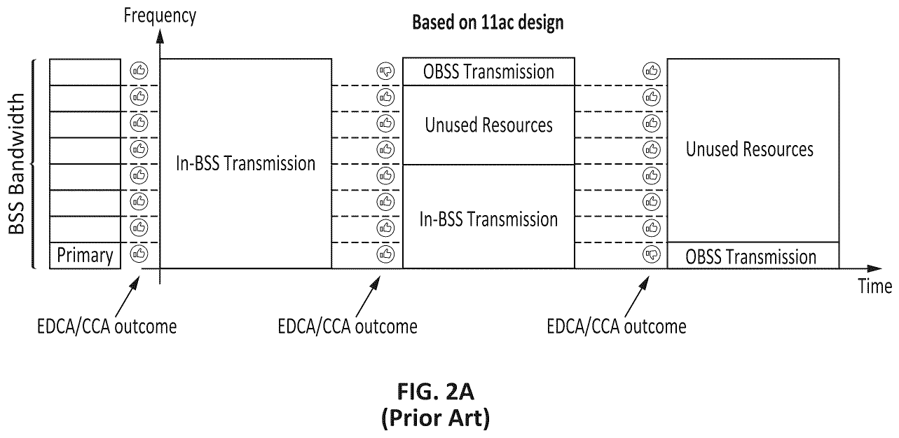

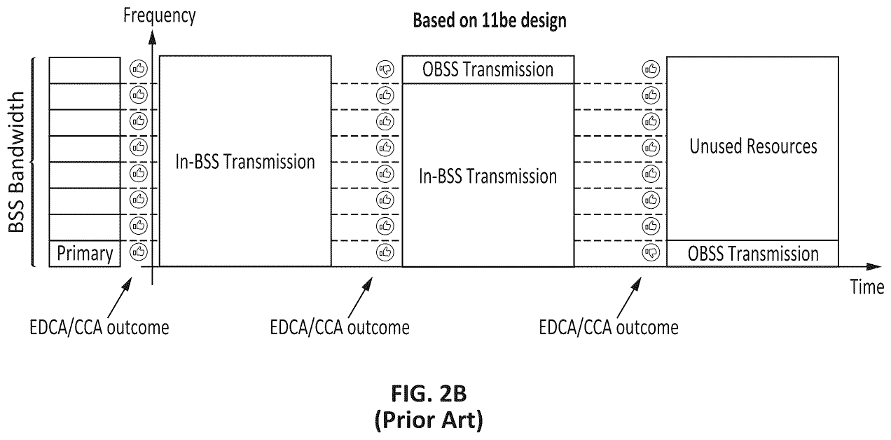

FIG. 2A and FIG. 2B depict high level state of art channel access procedures for channel bonding or multi-channel operation for 802.11ac in FIG. 2A, and 802.11be in FIG. 2B. Each of these depict BSS bandwidth on the left side followed by subfigures in the process, each of which depicts EDCA/CCA outcome along the left edge of each sub-figure.

More lately 802.11be has further improved this mode of operation through the support of 320 MHz. When the BSS bandwidth is larger than 20 MHz, for a device to obtain a TXOP, a specific channel access procedure is required. In this case, one or a group of channel bandwidths of the BSS bandwidth are declared as a primary channel and all others are defined as secondary channel or channels.

While until 802.11ac, a transmission can be only performed on both the primary channel and non-primary channel, with variable channel granularity of 20 MHz, 40 MHz and 80 MHz, if all of the channels are assessed to be idle. In 802.11 ax and 802.11be the procedure has been enhanced through the preamble puncturing functionality which allows a transmission to be performed in any of the available channels belonging to the initial BSS bandwidth, as long as the primary channel is assessed to be idle based on the EDCA procedure defined in Sec. 10.23.2 of specification IEEE P802.11-REVme/D4.1, “Part 11: Wireless LAN Medium Access Control (MAC) and Physical Layer (PHY) Specifications-Amendment 8: Enhancements for extremely high throughput (EHT)”, October 2023.

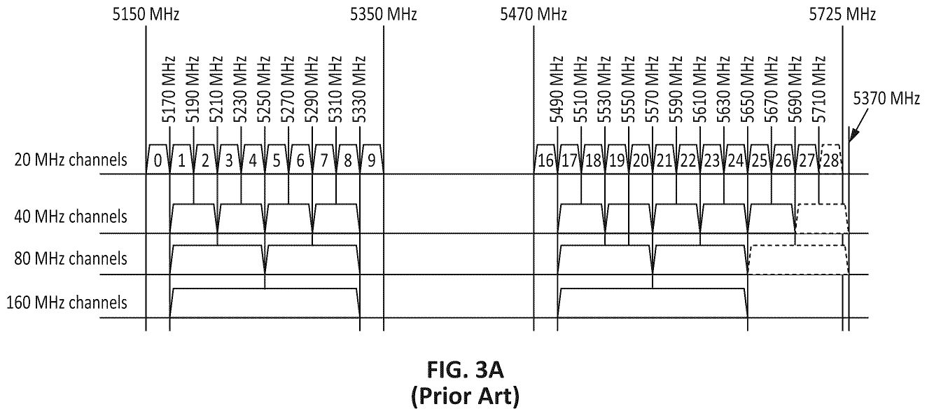

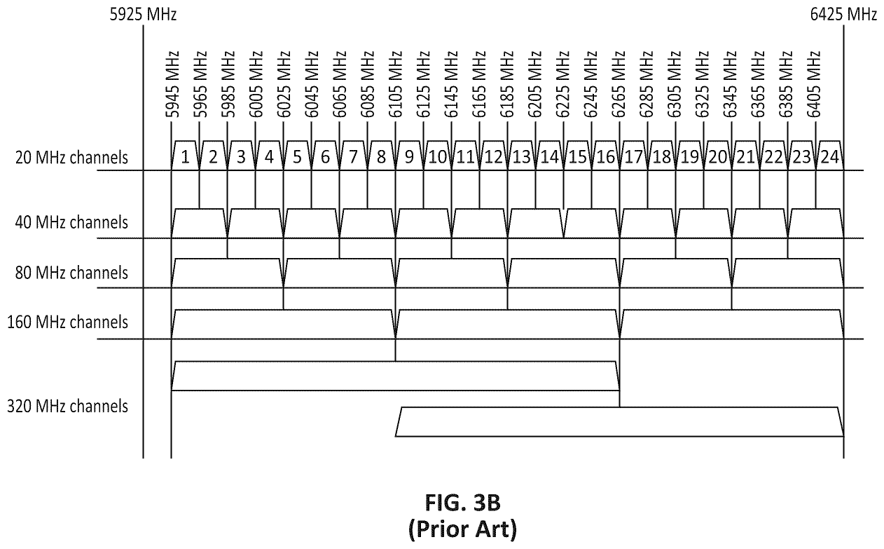

By means of regulatory requirements (i.e., ETSI BRAN: 301.893 5 “5 GHz RLAN; Harmonized Standard covering the essential requirements of article 3.2 of Directive 2014/53/EU” and 303.687 “6 GHZ WAS/RLAN; Harmonised Standard for access to radio spectrum”), channel bonding can be applied by grouping bandwidth of 40 MHZ, 80 MHz, 160 MHz and 320 MHz as shown in FIG. 3.

Furthermore, the regulatory requirements mandate equipment to satisfy the following requirements to be able to transmit:

the equipment shall satisfy the channel access mechanism for an initiating device as defined in clause 4.2.7.3.2.6 of ETSI BRAN 301.893, “5 GHz RLAN; Harmonised Standard covering the essential requirements of article 3.2 of Directive 2014/53/EU” and ETSI BRAN 303.687, “6 GHZ WAS/RLAN; Harmonised Standard for access to radio spectrum” on the primary operating channel and the equipment performs a Clear Channel Assessment (CCA) of at least 23 us immediately before the intended transmissions on each of the other operating channels on which transmissions are intended, and no energy was detected with a level above the Energy Detection Threshold (EDT) defined in clause 4.2.7.3.2.5 of the above references.

It should also be noted that the above references indicate that the choice of the primary operating channel shall follow one of the following procedures:

The primary operating channel is chosen uniformly randomly whenever the Contention Window (CW) corresponding to a completed transmission on the current primary operating channel is set to its minimum value (CWₘᵢₙ). For this procedure, a CW is maintained within each operating channel from the group of adjacent channels. The primary operating channel is arbitrarily determined and not changed more than once per second. Additionally, the above ETSI BRAN references mandate that once a group is selected it cannot be changed more than once per second.

### 3. Problem Statement

While during the 802.11ax and 802.11be, progress has been made in order to increase the spectrum efficiency of 802.11 design in case channel bonding or multi-channel operation is used by introducing the concept of preamble puncturing, the primary 20 MHz channel still remains a bottleneck in terms of performance and reliability for this type of system.

In fact, if there is an OBSS transmission that overlaps with the primary 20 MHz channel, independent of whether the remainder of the spectrum is utilized or not, no transmission is allowed to be performed, thus leading to a significant loss in spectrum utilization. As 802.11 systems support increasingly larger and larger bandwidths, protocols such as 802.11be support up to 320 MHz bandwidths, and the penalty of having a channel access procedure which has a single point of failure in the primary channel is becoming increasingly problematic as the unused spectrum becomes quite significant. In order to mitigate this issue, and lead to overall spectrum utilization improvements, a new channel access procedure is needed which is not subject to this single point of failure.

### 4. Embodiments of the Present Disclosure

### 4.1. Communication Station (STA and MLD) Hardware

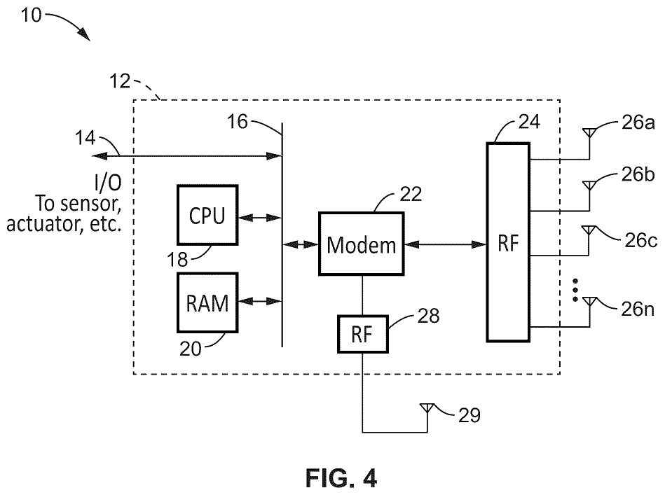

FIG. 4 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

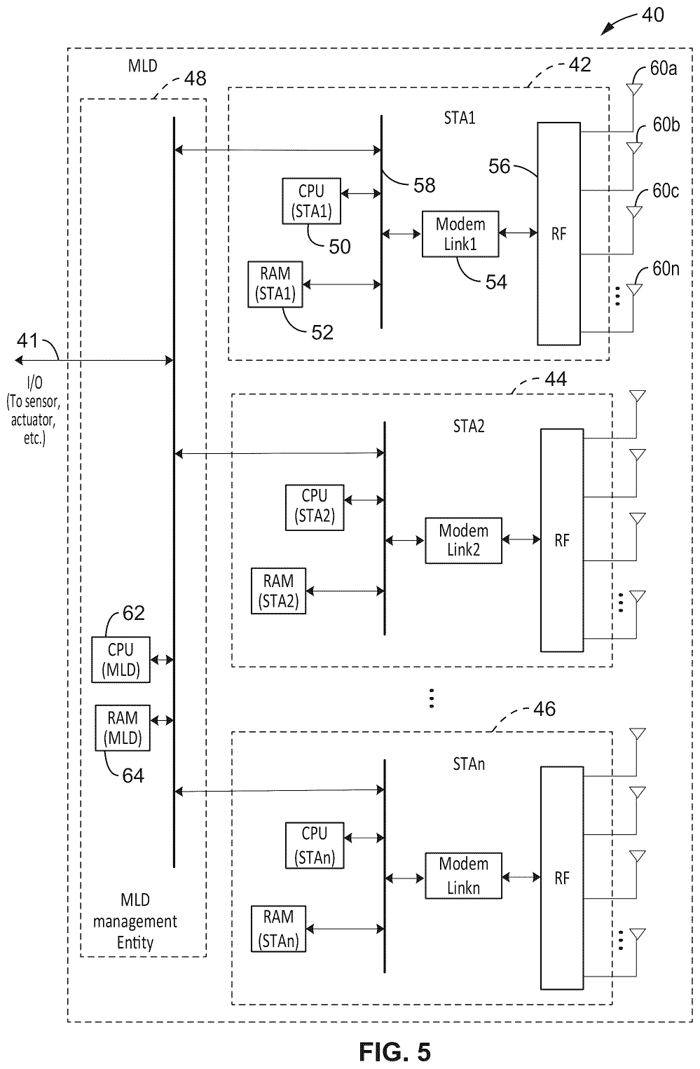

FIG. 5 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHZ), basic link set (2.4 GHz and 6 GHZ).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 4.2. Specific Embodiments of Channel Bonding or Multi-Channel Operations

In at least one embodiment, when channel bonding or multi-channel operation is performed, and a device is capable of such operation, and the intended primary channel is assessed to be busy, the initiating device may choose a non-primary channel to act as a primary channel to perform a wideband transmission in the immediately subsequent transmission occasion to improve spectrum utilization.

In the following discussions of this disclosure, non-primary channels are referred to as an operating channel when it is selected as an alternative to a primary channel when the primary channel is assessed to be busy and when channel bonding or multi-channel operation is operated.

In at least one embodiment, this use of non-primary channels as alternatives to a primary channel, may be applied and enabled based on capability and certain design considerations detailed in this disclosure for other embodiments only when certain amounts of BSS bandwidth are being utilized. As an example, a non-primary channel is only enabled when the BSS bandwidth is 160 MHz or 320 MHz.

### 4.3. Channel Selection

In another embodiment, the selection of the non-primary channel is performed based on one or more of the following criteria.

(a) The non-primary channel is selected among a set of predefined or pre-configured operating channels belonging to the same transmission Bandwidth (BW) or BSS bandwidth for which a transmission was meant (intended) to occur using the primary channel. (a)(i) As an alternative, the set of operating channels that can serve as non-primary channels are announced by the AP through a bitmap, which indicates which channel or channels can be utilized as a non-primary channel.

(b) The non-primary channel is selected among a group of pre-defined or pre-configured operating channels belonging to the same transmission BW or BSS bandwidth for which a transmission was meant (intended) to occur using the primary channel.

(c) The non-primary channel is a pre-defined or pre-configured operating channel belonging to the same transmission BW or BSS bandwidth for which a transmission was meant (intended) to occur using the primary channel.

(d) The non-primary channel is a pre-defined or pre-configured operating channel which does not necessarily belong to the same transmission BW or BSS bandwidth for which a transmission was meant (intended) to occur using the primary channel.

(e) An AP and client may negotiate multiple sets of channels where each set contains one primary channel, and each set of channels and the primary channel in each set is chosen semi-dynamically. In this semi-dynamic choosing of the selected non-primary channel for the purpose of Non-Primary Channel Access (NPCA), if an EDCA fails on one primary channel, then a new set is selected and the related primary channel in the different set is selected to operate as the non-primary channel. (e)(i) As a sub-option, the set of channels are of the same size or can each compose a different number of channels and different total bandwidth. (e)(ii) As a sub-option, each set of channels may be composed by consecutive/concurrent channels in the frequency domain. (e)(iii) As another sub-option, each set of channels may overlap, or partially overlap, in the frequency domain, except for the primary and non-primary channel that are always non-overlapping.

(f) The bandwidth of the non-primary channel could be n×20 MHz, where n is an integer between 1 to 15.

(g) The non-primary channel could be punctured if the bandwidth of the non-primary channel is larger than 40 MHz.

(h) In one option, once the non-primary channel is selected it is common (e.g., all the STAs consider this non-primary channel as the selected non-primary channel for the purposes of NPCA for themselves) for all the STAs within a BSS or across all STAs associated to BSSs which may coordinate with each other. In another option, if BSSs may coordinate with each other, the selection of the non-primary channel may or may not be common across STAs belonging to different BSSs. In a separate option, if BSSs may coordinate with each other, the selection of the non-primary channel is performed so that this is different per each BSS, but common across all the STAs of a BSS. In another option, each BSS may be associated with a set of channels that may be used as non-primary channels. The sets of channels may or may not overlap across collaborating or coordinating BSSs.

In at least one embodiment, once a non-primary channel is selected, the transmission BW associated with the initial transmission that was meant (intended) to be performed using the primary channel that is assessed to be busy is selected based on one of the following criteria.

(a) The operating channels forming the transmission BW are the same or a subset as the originally intended transmission bandwidth except that one of the operating channels is now acting as a non-primary channel.

(b) The operating channels forming the transmission BW are the same, or a subset of the originally intended transmission bandwidth, except for the non-primary channel;

(c) The operating channels forming the transmission BW are orthogonal to the set of operating channels that originally formed the intended transmission bandwidth except that one of the operating channels is now acting as a non-primary channel.

(d) The operating channels forming the transmission BW are orthogonal to the set of operating channels that originally formed the intended transmission bandwidth, including the channel that is now operating as a non-primary channel.

(e) The operating channels forming the transmission BW are part of predefined sets associated with a specific primary channel or non-primary channel. (e)(i) In one option of this embodiment, the transmission BW is composed by concurrent channels in frequency domain including the non-primary channel.

### 4.4. General Design of the Channel Access Procedure

In at least one embodiment, when a non-primary channel is used instead of a primary channel, since this has been assessed to be busy, one of the following mechanisms is used to acquire a TXOP.

(a) For non-primary channel access an EDCA mechanism is applied to assess whether this channel is idle or busy (same procedure as that performed on the primary channel in the legacy design), and a Point Coordination Interframe Space (PIFS) CCA is performed as in legacy design to each operating channel that form the new transmission bandwidth when the non-primary channel is assessed to be idle. Transmission is performed over the non-primary channel and all the operating channels that belong to the new transmission bandwidth for which it has been possible to verify that the medium is idle, upon assessment that the non-primary channel is idle.

(b) For the non-primary channel access an EDCA mechanism is applied to assess whether this channel is idle or busy (same procedure as that performed on the primary channel in the legacy design), and a PIFS CCA is performed as in a legacy design to each operating channel that form the new transmission bandwidth when the non-primary channel is assessed to be idle. Transmission is performed only if the non-primary channel, and all the operating channels that belong to the new transmission bandwidth, are assessed to be idle.

(c) Regardless of whether the channel assessment is done over a non-primary channel access, or any of the operating channels that forms the new transmission bandwidth, a PIFS CCA is performed for each operating channel to assess whether the medium is idle. Transmission is performed over the non-primary channel and all the operating channels that belong to the new transmission bandwidth for which it has been possible to verify that the medium is idle, upon assessment that the non-primary channel is idle.

(d) Regardless of whether the channel assessment is done over a non-primary channel access, or any of the operating channels that form the new transmission bandwidth, a PIFS CCA is performed for each operating channel to assess whether the medium is idle. Transmission is performed only if the non-primary channel, and all the operating channels that belong to the new transmission bandwidth, are assessed to be idle.

(e) In one option, once the non-primary channel is selected it is common for all the STAs within a BSS, or across all STAs associated to BSSs which may coordinate with each other. In another option, if BSSs are able to coordinate with each other, the selection of the non-primary channel may or may not be common across STAs belonging to different BSSs. In a separate option, if BSSs may coordinate with each other, the selection of the non-primary channel is performed, so that this is different per each BSS, but common across all the STAs of a BSS.

(f) Once the primary channel is assessed to be busy, a Multi-User (MU) EDCA with separate sets of EDCA parameters are performed over the non-primary channel(s), while a PIFS CCA is applied to all the operating channels serving as secondary channels. In one option, if multiple non-primary channels are associated to a BSS, a separate set of EDCA parameters is associated per each non-primary channel or a separate set of EDCA parameters is associated to the whole set of non-primary channels.

In at least one embodiment, regardless of the type of procedure used for the assessment on whether the medium is idle or busy, one or more of the following can be applied:

(a) The Energy Detection (ED) threshold utilized when the primary channel is assessed is also reused when the system switches to a non-primary channel.

(b) The ED threshold is utilized when the primary channel is assessed or recalculated, by considering the new transmission bandwidth. In particular, the new ED threshold is calculated in Equation 1 as follows:

$${X}^{′} = X - 10 log 10 ( {BW}_{old} / {BW}_{new} ) \qquad ( 1 )$$

where X′ is the ED threshold applied when the non-primary channel is used, X is the ED threshold applied when the primary channel is used, BW_{old} is the transmission bandwidth when the primary channel is used, and BW_{new} is the transmission bandwidth when the non-primary channel is used.

(c) The ED threshold for use by the STA is indicated by the AP which is calculated based on one of the principles described above.

(d) The ED threshold is determined differently based on whether the operating channels that are bounded with either the primary channel or the randomly selected non-primary channel are overlapped. In one example, if they overlap the same ED threshold is used between non-primary and non-primary channel, but if they do not overlap, the ED threshold may be different between the two, and performed the calculation based on the principles described above.

In at least one embodiment, if the non-primary channel is larger than 20 MHz, regardless of the type of procedure used for the assessment on whether the medium is idle or busy, one or more of the following can be applied.

(a) The Preamble Detection (PD) threshold utilized when the primary channel is assessed is also reused when the system switches to a non-primary channel.

(b) The PD threshold is utilized when the primary channel is assessed or recalculated by considering the new transmission bandwidth. In particular, the new PD threshold is calculated as per Eq. 1 above.

(c) The PD threshold utilized by the STA is indicated by the AP which is calculated based on one of the principles described above.

(d) The PD threshold is calculated differently based on whether the operating channels that are bounded with either the primary channel or the randomly selected non-primary channel are overlapped. In one example, if they overlap the same PD threshold is used between non-primary and non-primary channels, but if they do not overlap, the PD threshold may be different between the two and calculated based on the principles described above.

In at least one embodiment, one or more of the following can be applied based on device capability or system design.

(a) ED and Preamble Detection (PD) are both performed for each primary and non-primary channel available in a simultaneous manner.

(b) ED is performed for each primary and non-primary channel available in a simultaneous manner, while the PD is performed for those channels for which the ED threshold has passed, and once at a time based on whether the primary channel or selected non-primary channel has been assessed to be busy.

(c) Both the ED and the PD is performed once at a time for each channel starting from the primary channel first and then each selected non-primary channel based on whether those are assessed to be idle or busy. If one channel (primary or non-primary) is assessed to be idle, then there is no need to access the medium on other channels.

In at least one embodiment, a device can switch from a primary channel to a non-primary channel based on one or more of the following rules.

(a) The switch from the primary channel to the non-primary channel can be performed once for each given amount of time, such as being performed only once every second. So, once a non-primary channel is selected this should be used for at least a second, before switching back to the original primary channel or switching to a different non-primary channel.

(b) The switch can occur independently of time, but once the switch has occurred to a different channel than the original primary channel, the device should immediately switch back to the original primary channel for any of the subsequent transmissions or receptions, or after a certain number of TXOPs have been acquired.

(c) The switch can occur independently of time, but once the switch has occurred to a different channel than the original primary channel, the device should switch back to the original primary channel at the end of the TXOP, which can be either the TXOP associated with the non-primary channel operation, or it can be associated with that of the OBSS transmission or associated to the initial intended transmission over the primary channel or the TXOP associated with the concurrent transmission on the originally primary channel, for which the transmitter and receiver are hidden nodes from the OBSS and didn't switch to the non-primary channel.

In at least one embodiment, when a device switches from a non-primary channel to a primary channel one or more of the following rules apply.

(a) The switch occurs within an already established TXOP for which the primary channel serves as an operating channel. In this matter, until the end of the already established TXOP there is no need to perform any CCA or EDCA check on any channel. (a)(i) As a sub-option, a transmission can occur over the primary channel and any operating channel including the non-primary channel until the TXOP length elapses. (a)(ii) As a sub-option, a transmission can occur over the primary channel and any operating channel excluding the non-primary channel until the TXOP length elapses.

(b) The switch occurs within an already established TXOP for which the primary channel serves as an operating channel. In this matter, a PIFS CCA or an EDCA check is performed over the primary channel before the switch and before transmission can be performed over the TXOP using the primary channel. Also, a PIFS CCA may also be performed over any operating channel that would be used for transmission. (b) (i) As a sub-option, a transmission can occur over the primary channel and any operating channel including the non-primary channel that have been found to be idle until the TXOP length elapses. (b) (ii) As a sub-option, a transmission can occur over the primary channel and any operating channel that have been found to be idle excluding the non-primary channel until the TXOP length elapses.

(c) The switch occurs within an already established TXOP for which the primary channel does not serve as an operating channel. In this manner, the established TXOP is truncated and a new TXOP is acquired using the intended channel as the primary channel and by using the legacy procedure.

(d) The switch occurs within an already established TXOP for which the primary channel does not serve as an operating channel. In this manner, a legacy procedure is performed for the primary channel and the bandwidth of the established TXOP is expanded over the primary and non-primary channel and the associated idle operating channels, and the TXOP is considered valid until the length of the original established TXOP using the non-primary channel elapses.

In the case when multiple of the above rules are applied simultaneously, switching occurs based on the rule for which the switching is mandated first or last.

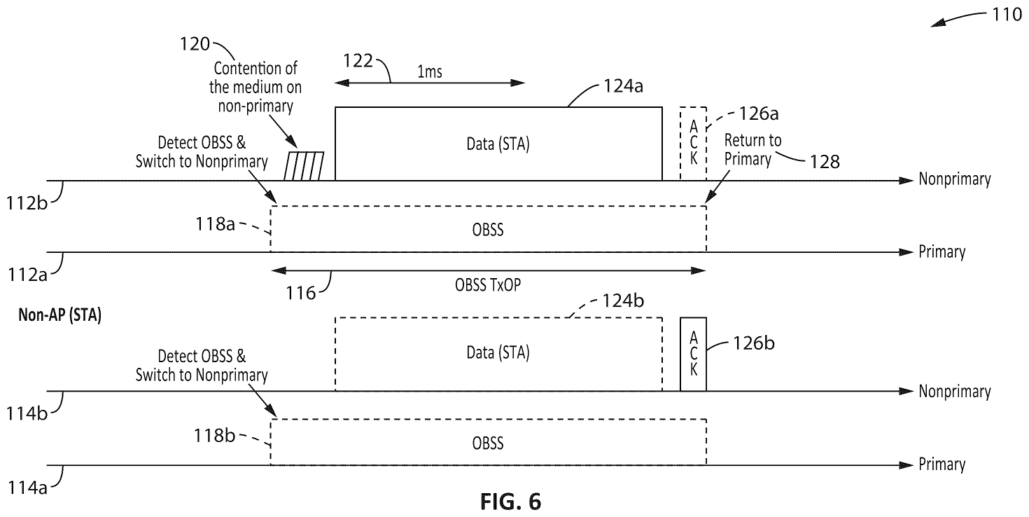

FIG. 6 illustrates an example embodiment 110 of frame exchange and switching from non-primary to primary channel operation. The figure depicts communications to/from the AP 112a, 112b, and to/from the Non-AP (STA) 114a, 114b. In this example switching can occur at most only once per second, and concurrently the device should switch back at the end of the TXOP which is associated with the TXOP of the interfering OBSS.

An OBSS transmission 118a, 118b is occupying the primary channel (both AP and non-AP STA) of the current BSS. Both AP and the STA affiliated with the current BSS detects the OBSS transmission on their primary channel 118a and 118b, and then switches to the non-primary channel. The AP contends 120 for channel access only on the non-primary channel, and after a random backoff the AP accesses the channel and transmits DATA 124a to the non-AP STA shown receiving DATA 124b from the AP, and sending a response ACK 126b, as received 126a by the AP. After this the OBSS TXOP 116 on the primary channel is completed, both the AP and STA switch back 128 to the primary channel.

In this specific case, the rule imposed is to switch based on the switching time that occurs later, and since the TXOP extends pass 1 ms, the switching occurs at the end of the TXOP of the associated OBSS.

In at least one embodiment, when a device switches from a primary channel to a non-primary channel to acquire a TXOP, one or more of the following is applicable. (a) No limitation is applied to the TXOP, and this is associated independently from other factors, such as OBSS transmission or initial attempt to acquire the channel through the primary channel. (b) The TXOP is limited to the duration of the TXOP based on when an attempt was made to initially acquire the intended primary channel. (c) The TXOP is limited to the duration of the TXOP associated with the OBSS transmission which is blocking the primary channel, and this limitation is utilized to ensure backward compatibility with legacy STAs.

In at least one option of this embodiment, multiple rules can be supported and applied based upon specific scenarios. For instance, if the primary channel is occupied by an OBSS, then the TXOP is at least limited based on the TXOP associated to the OBSS transmission, but if the channel is occupied by an incumbent technology, or the Basic NAV is not available, then no limitation is applied to the TXOP.

In at least one embodiment, the switching between the non-primary channel back to the primary channel can occur before the basic NAV timer. In this case, if a transmission may exceed the basic NAV timer and it may be transmitted over a non-primary channel, then the non-primary channel should not be used, and the transmission should be deferred and performed over the primary channel after the timer expires. In one option, this is only valid if the basic NAV timer is available.

In at least one embodiment, when a STA operates on a non-primary channel and it has valid basic NAV information available, and switching from the non-primary channel to the primary channel occurs before the basic NAV expires, it shall not account for the MediumSyncDelay timer and/or for the legacy NAVSyncDelay mechanism. On a separate option, the MediumSyncDelay timer and/or for the legacy NAVSyncDelay mechanism may not be required when an OBSS occurs on a non-primary channel starting from when the backoff is performed over this channel. In this case, a device can immediately switch back to the primary channel without the need of a medium synchronization recovery procedure.

In at least one embodiment, when a STA operates on a primary channel and switches to the non-primary channel due to the ongoing OBSS signal on the primary channel, then the STA can lose medium synchronization on the non-primary channel if the non-primary channel and the primary channel are adjacent channels and are interfering with each other. In this case, the STA should process the medium access recovery process on the non-primary channel as that in 802.11be. In this case, the values of the parameters aMediumSync Threshold, the MediumSyncDelay timer and the dot11MSDOFDMEDthreshold may be redesigned from 72 us, 5.484 ms and −72 dBm, respectively, to a new set of values according to the BW, MCS and other criteria on the primary channel and non-primary channel in NPCA scenario.

In at least one embodiment, when a STA operates on a non-primary channel and switches to the primary channel, the STA can lose medium synchronization on the primary channel if the non-primary channel and the primary channel are adjacent channels and are interfering with each other and there is an ongoing transmission on the non-primary channel that may or may not be from the STA belonging to its own BSS. In this case, the STA should perform a medium access recovery process on the primary channel as that described in 802.11be. In this case, the values for the parameters aMediumSyncThreshold, the MediumSyncDelay timer and the dot11MSDOFDMEDthreshold may be reconfigured from 72 us, 5.484 ms and −72 dBm, respectively, to a new set of values according to the BW, MCS and other criteria on primary channel and non-primary channel in NPCA scenario.

In at least one embodiment, when a device fails to acquire a primary channel because it was assessed to be busy, then the device may switch to using non-primary channel. If the channel access does not succeed on this new channel, then the device may switch onto the primary channel. For instance, only a single non-primary channel is used.

In another embodiment, when a device fails to acquire a primary channel because it is assessed as busy, then it may switch to one of a set of non-primary channels. If channel access does not succeed on one of these channels, then the device can switch to another non-primary channel. If the channel does not succeed on any of them, the device may switch again to the primary channel.

In at least one embodiment, an independent (separate) backoff is maintained between the primary and non-primary channel(s) while the same Access Category (AC) and other EDCA parameters are used across the two channels.

In a different embodiment, the backoff used in the primary channel is used in the EDCA of the non-primary channel and this information is shared between primary and non-primary channels together with all the EDCA parameters.

In a different embodiment, an independent backoff is maintained between the primary and non-primary channel(s) together with different EDCA parameters. In one option, whether to utilize a different EDCA parameter between primary and non-primary channel may depend on the bandwidth of the non-primary channel, its location, or whether the operating channels to be used at the same time that the primary and non-primary channels are used would be overlapping.

In at least one embodiment, whether the same or different backoff is used between the primary and non-primary channel(s), when a STA switches from one channel to another it always initiates a new random backoff within [0, CWₘᵢₙ].

In at least one embodiment, while the AP has switched to the non-primary channel it may still sense the primary channel after switching to the non-primary channel. In this case, the AP should still be able to detect the CCA status on the primary channel, and the AP may or may not be able to decode the preamble on the primary channel. In this case, the AP should not immediately switch back to the primary channel when the OBSS basic NAV duration expires because the primary channel is still detected as CCA busy. Alternatively, the AP may switch back to the primary channel earlier than the expiration of the OBSS basic NAV duration, if the AP hasn't detected CCA-busy on the primary channel for a specific time threshold.

### 4.5. General Design Considerations

In at least one embodiment, when a device switches from a primary channel to a non-primary channel to acquire a TXOP, the first transmission that is performed is a short Control frame which is used to confirm the presence of the peer STA on the primary channel.

In at least one embodiment, a non-AP STA may by default attempt to decode the preamble on the primary channel, and if the channel is assessed to be busy, but the non-AP STA cannot decode the preamble on the primary channel, then it may switch to a non-primary channel and adapt its baseband to receive over a set of operating channels associated with that non-primary channel.

In another embodiment, a non-AP STA may switch to a separated non-primary channel if explicitly instructed to do so by an AP. In this manner, the AP may perform an initial frame exchange signaling the specific non-primary channel, and any uplink transmission within the TXOP acquired through the use of a non-primary channel should be trigger-based.

In at least one embodiment, when a STA that supports non-primary channel access intends to transmit on a non-primary channel, it shall initiate the transmission using that channel with a control frame, such as a Ready-To-Send (RTS) frame.

In at least one embodiment, a new timer is defined which counts the time incurred (elapsed) from when a device switches to a non-primary channel, and then once the timer expires, an AP or non-AP STA would switch back to the primary channel. The new timer may or may not be updated during count down. In at least one similar embodiment, a new timer is defined which counts the time between the end of the last frame received, which is addressed to that device on the non-primary channel, and an AP or non-AP STA which switches back to the primary channel when this timer elapses.

In at least one embodiment, a new counter is defined which counts the number of TXOP which are acquired by a device when operating in a non-primary channel. The device may switch back to the original intended primary channel upon the counter reaching a certain value.

In at least one embodiment, a non-primary channel may be formed as a 20 MHz channel. In another embodiment, the non-primary channel may be formed by one or more 20 MHz channels.

### 4.5. General Considerations on Required Signaling

In at least one embodiment, an AP signals one or more of the following information elements. (a) Whether or not the AP supports the non-primary channel access procedure. (b) The effective location of the non-primary channel or non-primary channels. (c) The number of non-primary channels supported, in the case of more than one non-primary channel being supported. (d) The set of operating channels associated with the selected non-primary channel or the transmission BW. (e) Whether or not the non-primary channel access procedure is used, if it is supported. (f) The ED threshold to be used. (g) The duration of the TXOP. (g) Maximum number of TXOPs that can be utilized before switching. (h) The delays associated with switching from the primary to the non-primary channel. (i) Whether a new EDCA parameter set supports use in the non-primary channel, and if so, what is the new EDCA parameter set. (j) Information on one of the following: (1) the starting time of a potential transmission on a non-primary channel if the primary channel has failed; (2) time required to switch from the primary to the non-primary channel. (k) Delays associated with the switching from the non-primary to the primary channel, which indicate one of the following: (1) the starting time of a potential transmission on a primary channel after the non-primary channel has been used; and (2) the time required to switch from the non-primary channel to the primary channel.

In at least one embodiment, a non-AP STA communicates one or more of the following information elements: (a) whether or not it supports the non-primary channel access procedure; (b) the effective location of the non-primary channel that it intends to use; (c) whether or not the non-primary channel access procedure is to be used if switching is supported; (d) Delays associated with the switching from the primary to the non-primary channel, which indicates one of the following: (1) the starting time of a potential transmission on a non-primary channel if the primary channel has failed. (2) the time required to switch from the primary to the non-primary channel. (d) The delays associated with switching from the non-primary channel to the primary channel, which indicate one of the following: (1) the starting time of a potential transmission on a primary channel after the non-primary channel has been used; (2) the time required to switch from the non-primary channel to the primary channel. (e) Duration of the TXOP. (f) Maximum number of TXOPs before switching.

In at least one embodiment, for parameters that are provided by both AP and STA, the higher value is used. For instance, for the channel switch delay, the maximum value between the switch delay provided between AP and STAs is actually used by both if different. In one option, this may apply only to the group of devices that intend to communicate with each other.

In at least one embodiment, regardless of the delay indication from an AP or its non-AP STAs relating to their capability of switching from one channel to another, it is expected that the AP and all associated non-AP STAS would switch from the primary channel to the non-primary channel at the same time. This implies that the device would use the highest value between the one indicated and the one received from other devices for switching.

In at least one embodiment, a non-AP STAs would always rely on the delay indication provided by the AP.

In at least one embodiment, based on the above exchange of information, one or more of the following could be supported. (a) If an AP assesses that not all the STAs associated with that STA lack support for non-primary channel procedures, then the AP should disable this type of operation if supported. (b) If an AP supports the non-primary channel procedure, and enables this functionality, then all the STAs associated with it should consequently enable this functionality, as well, if supported. (c) If an AP supports the non-primary channel procedure, and enables this functionally, a STA is not mandated to enable it although it is supported. This is for instance the case where a STA may prefer to stay in power-saving mode and avoid wasting power in blind detection/decoding and additional complexity in supporting this feature. (d) If all the associated non-AP STAs disable the non-primary channel procedure, then the associated AP does not switch to the non-primary channel regardless of the capability. (e) When the AP announces that the non-primary channel procedure is to be enabled, then the non-AP STA that enables its non-primary channel procedure and has a trigger-based transmission, can switch to the non-primary channel and either initiate a TXOP to the AP or transmit within the TXOP acquired by the AP. (f) If the AP announces that the non-primary channel procedure is to be disabled, then the non-AP STAs do not switch to the non-primary channel procedure regardless of its capability or intention.

In at least one embodiment, the non-primary channel procedure capability shall be announced by an AP, and broadcasted by a non-AP STA associated by that AP.

### 4.6. General Considerations Related to R-TWT

In at least one embodiment, the rules and solutions for R-TWT are reused in the same manner as they are when a non-primary channel is used.

In at least one embodiment, an AP may announce through a management frame (e.g., in a beacon) that the R-TWT rules are not applied when switching to a non-primary channel if no R-TWT STA supports a switch to a non-primary channel. In this case, the STAs will operate according to the announcement of the AP.

In at least one embodiment, the AP may be continuing its non-low latency traffic frame exchanges at the start time of its R-TWT SP if no R-TWT STA supports the subchannel switch, and/or if no member of the R-TWT member supports the subchannel switch.

In at least one embodiment, when an AP as the TXOP holder has a TXOP in the non-primary channel(s) that covers its Target Beacon Transmission Time (TBTT) or Direct TBTT (DTBTT), the AP will not schedule its Beacon transmission at its TBTT or DTBTT.

In at least one embodiment, if a primary channel is blocked by an OBSS Target Wake Time (TWT) Service Period (SP), a BSS may switch to a non-primary channel to access the medium during that TWT SP, and may switch back when the related SP ends. In this case, upon announcement of the OBSS TWT Info, such as reception of the OBSS's beacon or information exchange among multiple APs, the AP and non-AP STAs in a BSS may switch from the primary channel to a non-primary channel until the end of the OBSS TWT SP.

It should be appreciated that the embodiments listed along this section are not mutually exclusive, and one or more of them may apply together.

4.7. Operability with Other Features

In at least one embodiment, when Non-Primary Channel Access (NPCA) and Spatial Reuse (SR) can be enabled at the same time, then the AP determines whether or not to enable one or the other, insofar as they are not enabled together.

In another embodiment, NPCA and SR can be enabled simultaneously, as long as they are used under specific conditions that may depend on the Received Signal Strength Indicator (RSSI) of the OBSS Physical layer Protocol Data Unit (PPDU). For instance, in one option, spatial reuse is enabled if the received RSSI of the OBSS PPDU is less than a specific threshold T, otherwise NPCA is enabled.

In another embodiment, NPCA and SR can be enabled simultaneously, yet only under specific conditions that may depend on the received RSSI of the OBSS PPDU. In this manner, in at least one option, spatial reuse is enabled if the received RSSI of the OBSS PPDU is less than a specific threshold T, otherwise NPCA is enabled. However, in order to avoid ambiguity between the AP and the non-AP STA in the choice of using NPCA and SR, a backoff or tolerance level B may be applied to the threshold to account for possible mismatch in the RSSI values obtained by the different devices. So in this case Equation 2 is true:

$$\{ \begin{matrix}RSSI < τ - β , then SR is used \\ RSSI \geq τ + β , then NPCA is used\end{matrix} \qquad ( 2 )$$

As an alternative, an AP may indicate explicitly to the non-AP STA whether SR or NPCA is used.

### 4.8. Added Considerations of Switching to a Non-Primary Channel

In at least one embodiment, when the basic Network Allocation Vector (NAV) from a OBSS on the primary channel is available, and its length is shorter than a predefined or preconfigured value, so no channel switch shall occur. This limitation is primarily on the basis of power saving purposes as switching to a non-primary channel may be limited to a short time frame.

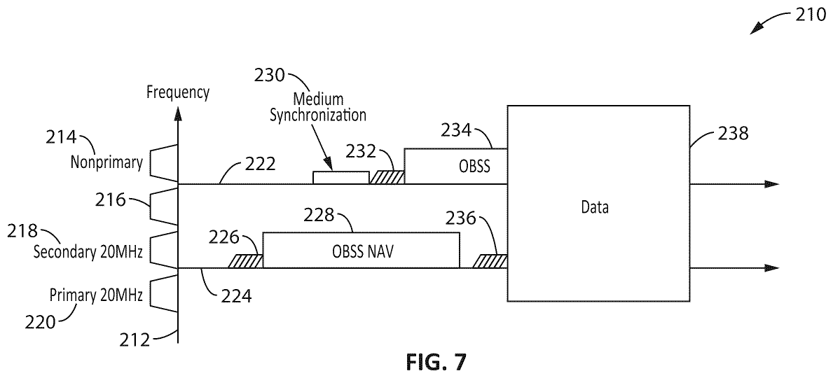

FIG. 7 illustrates an example embodiment 210 of a back and forth switch from the primary to the non-primary channel. A STA initially operates on 80 MHz of bandwidth as seen by the four 20 MHz channels: 214, 216, 218 and 220. First, after a random backoff 226 there is an OBSS TXOP transmission 228, which occupies the STA's primary 40 MHz channel (220+218). The STA has detected the duration of the OBSS from its NAV. The STA switches to it's non-primary channel 214. However, when the STA is processing medium synchronization recovery 230, there is another OBSS (different from the first OBSS) transmission which arises (232 and 234) and occupies the non-primary channel of the STA. The STA switches back to its primary channel (218+220) after the first OBSS NAV expired and after contending 236 for channel access, it transmits DATA 238.

In at least one embodiment, when a STA that supports non-primary channel access intends to transmit on a non-primary channel, yet during the medium synchronization process or while performing the backoff to acquire a TXOP using the non-primary channel, it receives an OBSS PPDU or it finds that the medium is occupied, it shall return to the primary channel immediately if the length of the OBSS PPDU is larger than X us or prolongs passing the PPDU OBSS occurring on the primary channel or both, Given that it will have information related to the basic NAV or PPDU duration in the non-primary channel, it may ignore this information when switching back to the primary channel if the non-primary channel is used as a secondary channel and the received power for that channel is less than −72 dBm. In this case, regardless of the NAV and PPDU duration in the non-primary channel, a transmission may occur overlapping this channel if the channel access procedure succeeds on the primary channel.

In another embodiment, as a STA receives an OBSS PPDU, and it intends to switch to a non-primary channel as soon as possible, then the time at which the switch is performed to the non-primary channel can occur independently of the OBSS PPDU, at the end of the received PPDU.

In another embodiment, as a STA receives an OBSS PPDU, and it intends to switch to a non-primary channel as soon as possible, the time of this switch to the non-primary channel can occur anytime after the L-SIG is received. This caveat is beneficial for long PPDUs so that the TXOP is usable as switching to non-primary channel may take be longer.

In another embodiment, as a STA receive an OBSS PPDU, and it intends to switch to a non-primary channel as soon as possible, the switch time to the non-primary channel can occur only after validating the duration field of the NAV in Medium Access Control (MAC) header, which is after successfully receiving MAC Protocol Data Unit (MPDU) in an Aggregate MPDU (A-MPDU) or before the end of the whole frame.

In another embodiment, as a STA receive an OBSS PPDU and it intends to switch to a non-primary channel as soon as possible, yet in this case the received frame is or contains an Ready-To-Send (RTS) or Multi-User (MU)-RTS, then one of the following rules may apply: (a) the switch time to the non-primary channel can occur after the NAV timeout; (b) the switch time to the non-primary channel may occur after the STA receives a Clear-To-Send (CTS), such as after a control frame exchange, which confirms the basic NAV set after the CTS; (b) the switch time to the non-primary channel may occur after successfully receiving MPDU in an A-MPDU or before the end of the whole frame.

It should be appreciated that the embodiments listed in these sections are not mutually exclusive, and one or more of them may apply together.

### 4.9. General Considerations on Capability

In at least one embodiment, multiple device capabilities for both AP and STA may be defined based upon one or more of the following considerations: (a) number of non-primary channels supported; and (b) whether the non-primary channel operation is supported or not.

### 5. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A station apparatus for communication in a wireless network, the apparatus comprising: (a) at least one modem coupled to at least one radio-frequency (RF) circuit, with each RF circuit connected to one or multiple antennas; (b) wherein said station (STA) is configured as a separate STA or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol, comprising: (e)(i) wherein said STA operates in the wireless communications protocol as either an Access Point (AP) STA within its basic service set (BSS), or a non-AP STA, for communicating with other STAs on the WLAN; and (e)(ii) wherein upon determining that a primary channel is busy, on which the STA as initiating STA intended to perform a channel bonding or multi-channel operation, said STA chooses a non-primary channel to act in the manner of a primary channel to perform subsequent wideband transmissions.

A station apparatus for communication in a wireless network, the apparatus comprising: (a) at least one modem coupled to at least one radio-frequency (RF) circuit, with each RF circuit connected to one or multiple antennas; (b) wherein said station (STA) is configured as a separate STA or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol, comprising: (e)(i) wherein said STA operates in the wireless communications protocol as either an Access Point (AP) STA within its basic service set (BSS), or a non-AP STA, for communicating with other STAs on the WLAN; (e)(ii) wherein upon determining that a primary channel is busy, on which the STA as initiating STA intended to perform a channel bonding or multi-channel operation, said STA chooses a non-primary channel to act in the manner of a primary channel to perform subsequent wideband transmissions; and (e)(iii) wherein the non-primary channel is selected: (a) among a group of predefined or pre-configured operating channels within a transmission bandwidth (BW), or BSS bandwidth; or (b) based on an announcement of non-primary channels from an AP STA of the BSS.

A method of communication in a wireless network, the apparatus comprising: (a) wirelessly communicating between stations (STAs) in an IEEE 802.11 wireless local area network (WLAN), in which each said STA is configured as a separate STA or as a STA within a multiple-link device (MLD); and (b) selecting a non-primary channel to act in the manner of a primary channel in performing wideband transmissions, after determining that said primary channel is busy over which an intended channel bonding or multi-channel operation was intended.

A method and apparatus for operating a non-primary channel access when a channel bonding or multi-channel operation is performed and a device is capable for such operation, and the intended primary channel is assessed to be busy, then the initiating device chooses a non-primary channel to act as a primary channel to perform a wideband transmission in the immediately subsequent transmission occasion.

The apparatus or method of any preceding implementation, wherein the non-primary channel is selected among a group of predefined or pre-configured operating channels within a transmission bandwidth (BW), or BSS bandwidth.

The apparatus or method of any preceding implementation, wherein a set of operating channels that can serve as non-primary channels are announced by an AP STA of the BSS.

The apparatus or method of any preceding implementation, wherein said announcement of the set of operating channels is communicated in a bitmap indicating which channel or channels can be utilized as non-primary channels.

The apparatus or method of any preceding implementation, wherein a negotiation is performed to determine multiple sets of channels, wherein each set contains one primary channel.

The apparatus or method of any preceding implementation, wherein each set of non-primary channels are chosen semi-dynamically comprising selecting a new set of channels to operate as the primary channel when an enhanced distributed channel access (EDCA) fails on one primary channel.

The apparatus or method of any preceding implementation, wherein prior to performing said wideband transmissions on the non-primary channel which is acting as a primary channel, the non-primary channel is accessed using enhanced distributed channel access (EDCA) and a point coordination interframe space (PIFS) clear channel assessment (CCA) is performed, and upon determining that the non-primary channel is idle, then transmission is performed over the non-primary channel as if it were the primary channel.

The apparatus or method of any preceding implementation, wherein determining that the non-primary channel is idle utilizes an energy detection (ED) threshold or a preamble detection (PD) threshold.

The apparatus or method of any preceding implementation, wherein switching from the primary channel to the non-primary channel can be performed only once per given amount of time.

The apparatus or method of any preceding implementation, wherein switching from the primary channel to the non-primary channel can be performed only once per second.

The apparatus or method of any preceding implementation, further comprising a new timer being utilized for counting elapsed time from switching to the non-primary channel; wherein upon timer expiration a switch is performed back to the primary channel.

The apparatus or method of any preceding implementation, wherein after switching from the primary channel to the non-primary channel, the STA switches back to the original primary channel for subsequent transmissions or receptions, or at the end of the TXOP, or after a certain number of TXOPs have been acquired.

The apparatus or method of any preceding implementation, wherein if a switch from the primary channel to the non-primary channel is performed within a TXOP, then the STA bypasses the need to perform any CCA or EDCA checks on whether the channel is idle and commences transmission.

The apparatus or method of any preceding implementation, further comprising utilizing a separate backoff between the primary and non-primary channel, while using an identical Access Category (AC).

The apparatus or method of any preceding implementation, further comprising utilizing a backoff for the non-primary channel which is identical to that used for the primary channel.

The apparatus or method of any preceding implementation, wherein after a switch is made from the primary channel to the non-primary channel, the STA continues sensing the CCA status of the primary channel.

The apparatus or method of any preceding implementation, wherein after switching from the primary channel to the non-primary channel to acquire, a short control frame is transmitted to confirm the presence of a peer STA on the primary channel.

The apparatus or method of any preceding implementation, wherein prior to performing said wideband transmissions on the non-primary channel which is acting as a primary channel, the non-primary channel is accessed using enhanced distributed channel access (EDCA) and a point coordination interframe space (PIFS) clear channel assessment (CCA) is performed, and upon determined the non-primary channel to be idle then transmission is performed over the non-primary channel as if it were the primary channel.

The apparatus or method of any preceding implementation, wherein multiple criteria on how the selection of the non-primary channel is performed are utilized.

The apparatus or method of any preceding implementation, wherein multiple criteria are utilized on how the transmission BW is determined when switching from a primary to a non-primary channel.

The apparatus or method of any preceding implementation, wherein multiple mechanisms on how to acquire a TXOP are utilized when switching from a primary to a non-primary channel.

The apparatus or method of any preceding implementation, wherein multiple options are utilized on how to determine the ED threshold when switching from the primary to the non-primary channel.

The apparatus or method of any preceding implementation, wherein multiple options are utilized to determine the PD threshold when switching from the primary to the non-primary channel, and when the non-primary channel is larger than 20 MHz.

The apparatus or method of any preceding implementation, wherein multiple options are utilized on how to perform ED and PD detection together.

The apparatus or method of any preceding implementation, wherein multiple options are designed on the timing of when switching should occur from a non-primary channel back to a primary channel.

The apparatus or method of any preceding implementation, wherein multiple options are provided on how and whether to limit the TXOP of the non-primary channel when a device switches from the primary channel to the non-primary channel to acquire a TXOP.

The apparatus or method of any preceding implementation, wherein multiple rules and design considerations are utilized to determine when a device should switch back to a primary channel from a non-primary channel.

The apparatus or method of any preceding implementation, wherein multiple options regarding whether the LBT on the primary and the non-primary should be related to each other and for instance whether the backoff should be independently performed or not, and whether or not to define a new set of EDCA parameters.

The apparatus or method of any preceding implementation, wherein the signaling required by both AP and non-AP STA to operate such feature are indicated together on how these are related to each other.

The apparatus or method of any preceding implementation, wherein multiple design options are disclosed on when this feature should be enabled considering device capabilities, and on whether one or more of them may signal the enablement or disablement of this type of operation.

The apparatus or method of any preceding implementation, wherein multiple design options can be utilized on how to operate a non-primary channel access procedure jointly with the R-TWT and related design considerations.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A station apparatus for communication in a wireless network, the apparatus comprising:
(a) at least one modem coupled to at least one radio-frequency (RF) circuit, with each RF circuit connected to one or multiple antennas;
(b) wherein said station (STA) is configured as a separate STA or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol, comprising:
(i) wherein said STA operates in the wireless communications protocol as either an Access Point (AP) STA within its basic service set (BSS), or a non-AP STA, for communicating with other STAs on the WLAN; and
(ii) wherein upon determining that a primary channel is busy, on which the STA as initiating STA intended to perform a channel bonding or multi-channel operation, said STA chooses a non-primary channel to act in the manner of a primary channel to perform subsequent wideband transmissions.

2. The apparatus of claim 1, wherein the non-primary channel is selected among a group of predefined or pre-configured operating channels within a transmission bandwidth (BW), or BSS bandwidth.

3. The apparatus of claim 1, wherein a set of operating channels that can serve as non-primary channels are announced by an AP STA of the BSS.

4. The apparatus of claim 3, wherein said announcement of the set of operating channels is communicated in a bitmap indicating which channel or channels can be utilized as non-primary channels.

5. The apparatus of claim 1, wherein a negotiation is performed to determine multiple sets of channels, wherein each set contains one primary channel.

6. The apparatus of claim 5, wherein each set of non-primary channels are chosen semi-dynamically comprising selecting a new set of channels to operate as the primary channel when an enhanced distributed channel access (EDCA) fails on one primary channel.

7. The apparatus of claim 1, wherein prior to performing said wideband transmissions on the non-primary channel which is acting as a primary channel, the non-primary channel is accessed using enhanced distributed channel access (EDCA) and a point coordination interframe space (PIFS) clear channel assessment (CCA) is performed, and upon determining that the non-primary channel is idle, then transmission is performed over the non-primary channel as if it were the primary channel.

8. The apparatus of claim 7, wherein determining that the non-primary channel is idle utilizes an energy detection (ED) threshold or a preamble detection (PD) threshold.

9. The apparatus of claim 1, wherein switching from the primary channel to the non-primary channel can be performed only once per given amount of time.

10. The apparatus of claim 9, further comprising a new timer being utilized for counting elapsed time from switching to the non-primary channel; wherein upon timer expiration a switch is performed back to the primary channel.

11. The apparatus of claim 1, wherein switching from the primary channel to the non-primary channel can be performed only once per second.

12. The apparatus of claim 1, wherein after switching from the primary channel to the non-primary channel, the STA switches back to the original primary channel for subsequent transmissions or receptions, or at the end of the TXOP, or after a certain number of TXOPs have been acquired.

13. The apparatus of claim 1, wherein if a switch from the primary channel to the non-primary channel is performed within a TXOP, then the STA bypasses the need to perform any CCA or EDCA checks on whether the channel is idle and commences transmission.

14. The apparatus of claim 1, further comprising utilizing a separate backoff between the primary and non-primary channel, while using an identical Access Category (AC).

15. The apparatus of claim 1, further comprising utilizing a backoff for the non-primary channel which is identical to that used for the primary channel.

16. The apparatus of claim 1, wherein after a switch is made from the primary channel to the non-primary channel, the STA continues sensing the CCA status of the primary channel.

17. The apparatus of claim 1, wherein after switching from the primary channel to the non-primary channel to acquire, a short control frame is transmitted to confirm the presence of a peer STA on the primary channel.

18. A station apparatus for communication in a wireless network, the apparatus comprising:
(a) at least one modem coupled to at least one radio-frequency (RF) circuit, with each RF circuit connected to one or multiple antennas;
(b) wherein said station (STA) is configured as a separate STA or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol, comprising:
(i) wherein said STA operates in the wireless communications protocol as either an Access Point (AP) STA within its basic service set (BSS), or a non-AP STA, for communicating with other STAs on the WLAN;
(ii) wherein upon determining that a primary channel is busy, on which the STA as initiating STA intended to perform a channel bonding or multi-channel operation, said STA chooses a non-primary channel to act in the manner of a primary channel to perform subsequent wideband transmissions; and
(iii) wherein the non-primary channel is selected: (a) among a group of predefined or pre-configured operating channels within a transmission bandwidth (BW), or BSS bandwidth; or (b) based on an announcement of non-primary channels from an AP STA of the BSS.

19. The apparatus of claim 18, wherein prior to performing said wideband transmissions on the non-primary channel which is acting as a primary channel, the non-primary channel is accessed using enhanced distributed channel access (EDCA) and a point coordination interframe space (PIFS) clear channel assessment (CCA) is performed, and upon determined the non-primary channel to be idle then transmission is performed over the non-primary channel as if it were the primary channel.

20. A method of communication in a wireless network, the apparatus comprising:
(a) wirelessly communicating between stations (STAs) in an IEEE 802.11 wireless local area network (WLAN), in which each said STA is configured as a separate STA or as a STA within a multiple-link device (MLD); and
(b) selecting a non-primary channel to act in the manner of a primary channel in performing wideband transmissions, after determining that said primary channel is busy over which an intended channel bonding or multi-channel operation was intended.
